(19) United States
(12) Patent Application Publication
(10) Pub. No.: US 2022/0041477 A1
(43) Pub. Date: Feb. 10, 2022

(54) INCREASED WASTEWATER FLOW WITH FENTON's REAGENT

(71) Applicant: Geomatrix, LLC, Old Saybrook, CT (US)

(72) Inventors: David A. Potts, Lyme, CT (US); Sara K. Wigginton, Ashaway, RI (US)

(21) Appl. No.: 17/395,760

(22) Filed: Aug. 6, 2021

Related U.S. Application Data
(60) Provisional application No. 63/062,562, filed on Aug. 7, 2020.

(51) Int. Cl. C02F 1/72

(52) U.S. Cl. CPC C02F 1/725; C02F 2103/005; C02F 2209/08; C02F 2305/026

(57) ABSTRACT

Use of Fenton's reagent or modified Fenton's reagent is described to promote rejuvenation of water treatment systems hampered by bioclogging matter. Hydraulic flow through one or more components of the water treatment system may be enhanced through the use of modified Fenton's reagent.

### CROSS-REFERENCE TO RELATED APPLICATIONS

This application claims priority to U.S. provisional application No. 63/062,562, which was filed on Aug. 7, 2020, and is entitled Modified Fenton Reagent Remediation. The '562 provisional is incorporated by reference, in its entirety, into this application.

### TECHNICAL FIELD

This application regards systems, apparatus, articles of manufacture, and processes for rejuvenating water treatment systems. These water treatment systems may include wastewater treatment systems, such as septic systems, stormwater treatment systems, and the like. The rejuvenation can comprise reduction, removal, and/or dispersing of bioclogging matter in a water treatment system and thereby promote enhanced hydraulic flow in the water treatment system.

### BACKGROUND

Water having various sources including septic wastewater, storm water, and process water (all of which may herein be collectively referred to as (“water”)) may be treated via a water treatment system. Water treatment systems can vary in size and scope. They can be sized for treatment of large amounts of water from a municipality or other large cumulative systems for benefitting many residences, businesses, and industrial facilities serviced by the municipality. The water treatment system can also be designed and sized for single home residential use and small scale residential and commercial uses.

In the small-scale applications, a water treatment system will often include a treatment tank that can receive water, allow for solids from the water to settle out as well as mitigate: Biological Oxygen Demand (BOD); Total Suspended Solids (TSS); nitrogen; Phosphorus; and bacteria and pathogens, among other constituents. Water treatment system will also often include an infiltration system downstream of a treatment tank for receiving the water from the treatment tank, treating the water, and for discharging the water back to the environment for further treatment and groundwater recharge. The infiltration system can include one or more infiltration field comprised of any type of leaching, infiltration or treatment and dispersal system used for returning water back to the environment or used to treat filtration systems that treat water. These infiltration fields as well as other components of a water treatment system can become flow restricted with organic matter and/or biological microorganisms.

When moving through a water treatment system water may pass through various filters and/or interfaces. These filters and/or interfaces may be located at various points of the treatment system including at a treatment tank and at an infiltration field. These filters and/or interfaces may lose their passibility and, thus, exhibit less hydraulic conductivity from a build-up of bioclogging matter, e.g., biological clogging matter and/or organic clogging matter. This bioclogging can serve to reduce or even stop the performance of filters or interfaces of a water treatment system, as well as the water treatment system in its entirety in severe bioclogging situations.

### BRIEF DESCRIPTION OF THE SEVERAL VIEWS OF THE DRAWINGS

FIG. 1 shows a cross-sectional schematic of bioclogging and hydraulic flow before and after application of Fenton's reagent or modified Fenton's reagent, as may be employed in some embodiments.

FIG. 2 shows a cross-sectional schematic of hydraulic potential across an interface or filter before and after application of Fenton's reagent or modified Fenton's reagent, as may be employed in some embodiments.

FIG. 3 shows a schematic of a water treatment system that may be rejuvenated in some embodiments.

FIG. 4 provides a flow chart showing a process of reducing or eliminating bioclogging of an infiltration field of a water treatment system, as may be employed in some embodiments.

FIG. 5 provides a decision flow chart showing the selection of peroxide concentrations for different soil types, as may be employed in some in embodiments.

FIG. 6 provides a schematic of a water treatment system and its components, which may each be rejuvenated in some embodiments.

FIG. 7 provides a high-level schematic overview of processes, as may be employed in some in embodiments.

FIG. 8 is a graph of pre-treatment water flow in a mesocosm system.

FIG. 9 is a graph of water flow in a mesocosm system after treatment with modified Fenton's reagent.

### DETAILED DESCRIPTION

Water treatment systems, e.g., stormwater treatment systems and septic treatment systems, which may generally consist of a settlement or treatment tank that treats water before it is directed to an infiltration field for final dispersal, are intended to remove pathogens and reduce carbon and other nutrient loads before water is recharged to the surrounding environment. While some carbon may be consumed and stored within an upstream treatment tank in such systems, water with high concentrations of organic matter can nevertheless be transported to an infiltration field. Organic material that is dosed to an infiltration field may be consumed and decomposed by a heterotrophic microbial community (e.g., bacteria and archaea that require a carbon source to fuel their metabolic activities). The microorganisms, in these instances, remove carbon from the water and incorporate it into their own mass or release it from the system as carbon dioxide. However, overloaded water treatment systems may not be able to remove the necessary biological and organic matter and bioclogging can result. This bioclogging can slow or even stop the flow of water through a water treatment system.

To maintain hydraulic function under these conditions, infiltration fields or other components of a water treatment system may be designed to handle water flows larger than the actual average daily use or daily rainfall; this value may be known as the design flow. For example, in single family residential water treatment system, the design flow may be based on the size of the home and the long-term acceptance rate (“LTAR”) of the soil underneath the infiltration field(s). The more bedrooms in a home and the smaller the LTAR, the larger the design flow (and therefore the size of the infiltration field(s)). For water treatment systems handling stormwater, the design flow and system sizing calculation may be based on factors such as the runoff volume, the percentage of impervious surface, and the area of the site.

A water treatment system that is undersized or that frequently receives flows near the peak design flows may be likely to decrease in function overtime and become “stressed,” e.g., slow to accept water, and may eventually fail. The root of this slowing or failure is usually the development of bioclogging matter such as “clogging biomat,” e.g., an overproduction of bacteria that forms an impenetrable layer of living and dead bacteria cells, their associated by-products, and organic waste products at or near an infiltrative surface or pass-through filter. A water treatment system that is overused or undersized may be at a much higher risk of bioclogging matter formation because of the reduced oxygen levels present when infiltration fields or other components of a water treatment system remain saturated or when the water treatment system receives high organic matter loads. Periods of high oxygen concentrations within the soil pores of the infiltration field may serve to maintain a homoeostatic microbial community that has the oxygen needed to decompose enough organic matter from the treatment tank and from dead microbial cells to keep water flowing through the profile of the water treatment system and to the surrounding environment.

Hydrogen peroxide (H₂O₂) is a powerful oxidation agent that may be used for oxidation of bioclogging matter in: water treatment systems, constructed wetland clogging reversal, and water treatment, among other uses. As explained herein, in some embodiments, hydrogen peroxide may be used for oxidation of bioclogging matter in water treatment systems. Generally speaking, as taught herein, H₂O₂ may be applied to promote a higher percentage of ozone (O) and Oxygen (O₂) in an infiltration field or other component of a water treatment system. This additional oxygen may be in lieu of or in addition to oxygen provided by a blower, vacuum, or other airflow source. This additional oxygen may react with organic matter and/or biological matter and lead to decomposition or removal of this bioclogging matter. This decomposition, disbursal or removal can serve to enhance hydraulic flow or other performance of an infiltration field or other component(s) of a water treatment system. In the case of H₂O₂, the direct reactivity of the peroxide with organic matter may be secondary to the oxidation carried out by the free radicals that form when H₂O₂ reacts with inorganic compounds, such as mineral surfaces and transition metals.

Embodiments may relate to processes, systems, articles of manufacture, and apparatus, directed to rejuvenation of water treatment systems, e.g., wastewater treatment systems, such as: septic systems, stormwater treatment systems, and the like, and including any associated infiltration fields (which may be referred to herein as “water treatment systems”). Embodiments may serve to reduce or remove bioclogging matter, e.g., biological and/or organic clogging, organic sludge, biomat, and/or other organic or biological solids, in a water treatment system and thereby promote enhanced hydraulic flow. The bioclogging matter may be derived, at least in part, from septic waste. The bioclogging matter may be derived at least approximately 30% by weight or volume from septic waste. The bioclogging matter may be derived at least approximately 30%, 35%, 40%, 45%, 50%, 55%, 60%, 65%, 70%, 75%, 80%, 85%, 90%, 95%, or 98% by weight or volume from septic waste. The bioclogging matter may be derived approximately entirely (approximately 100% by weight or volume) from septic waste. Septic waste may comprise waste from any or all of households, businesses, and/or municipalities. Septic waste may comprise waste that is, in the ordinary course of business or household life, disposed of down sink, toilet, laundry, lawn, storm, and/or other drains. Septic waste may not comprise more than approximately 1%, 2%, 5%, 10%, 15%, 20%, 25%, 30%, or 33% by weight or volume of contaminants that would be considered under government standards to be toxic contaminants. The reduction or removal of bioclogging matter may occur through oxidation and removal of the bioclogging matter.

Embodiments may be employed before and/or when a water treatment system is slow or failing to treat and disperse wastewater. Embodiments may be employed before and/or when a water treatment system is overloaded with wastewater/stormwater and/or organic matter, causing low levels of oxygen within an infiltration field (both because microbial decomposition of organic matter consumes oxygen and because the oxygen concentrations in water are many thousands of times lower than oxygen concentrations in air). These deleterious situations may occur when a water treatment system is overused, the infiltration field is undersized, or if there is an addition of materials to the water treatment system that are noncompatible with treatment in the infiltration field. Embodiments may also be employed when a water treatment system is operating normally, or close to normally, and it is desirable to inhibit or prevent slowing or failing.

In some embodiments, a stabilized oxidizing agent and a metal catalyst may be introduced to components of a water treatment system for rejuvenation or enhancement. The stabilized oxidizing agent can be introduced to promote the production of powerful oxidizing free radicals' species capable of oxidizing organic accumulation and biologic accumulation in and/or around an infiltration field or other component of a water treatment system. In some embodiments, the pH of a remediation solution being employed may be near neutral (e.g., between 5 and 8) and may help to control the turnover rate of a catalyst, such as the metal catalyst. In so doing, hydraulic flow of the rejuvenated water treatment system component may be enhanced. This enhancement may include improved water flow rates and/or improved hydraulic conductivity and/or hydraulic potentials.

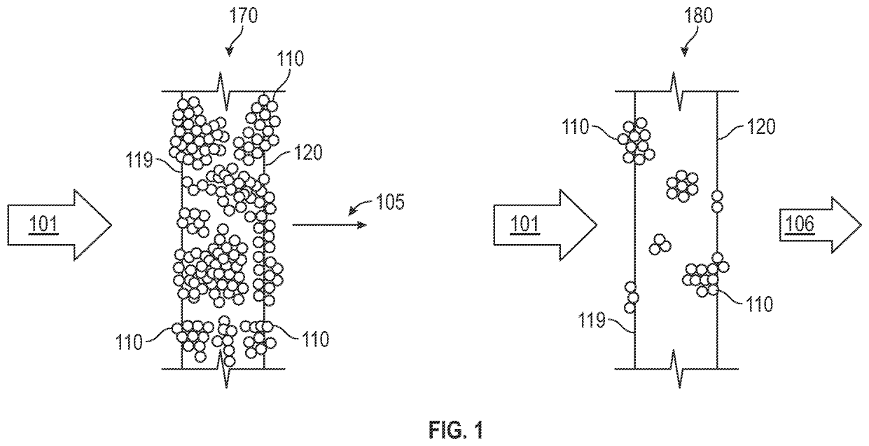

FIG. 1 shows a cross-sectional schematic of bioclogging matter and hydraulic flow at an infiltrative interface before and after application of Fenton's reagent or modified Fenton's reagent, as may be employed in some embodiments. Infiltrative interface is shown at 170 before application of Fenton's reagent or modified Fenton's reagent and after application at 180. As can be seen, the infiltrative interface has a receiving infiltrative surface at 119 and an exiting infiltrative surface at 120. Water flow is shown at 101 at the receiving infiltrative surface 119 and at 105 and 106 for the exiting infiltrative surface. The bioclogging matter is shown at 110. As can be seen in FIG. 1 there is much more bioclogging matter 110 before the application of the Fenton's reagent or modified Fenton's reagent (at 170) than after the application of the Fenton's reagent or modified Fenton's reagent (at 180). Because of the reduction of bioclogging matter 110, water flow is increased as is depicted by the sizes of arrows 105 and 106. As can also be seen in FIG. 1, the bioclogging matter 110 is more prevalent at 170 than at 180, but still allows for some water flow through the infiltrative interface 170 and its infiltrative surfaces 119 and 120. In some embodiments, no hydraulic flow path may exist through an infiltrative interface prior to the application of Fenton's reagent or modified Fenton's reagent as taught herein.

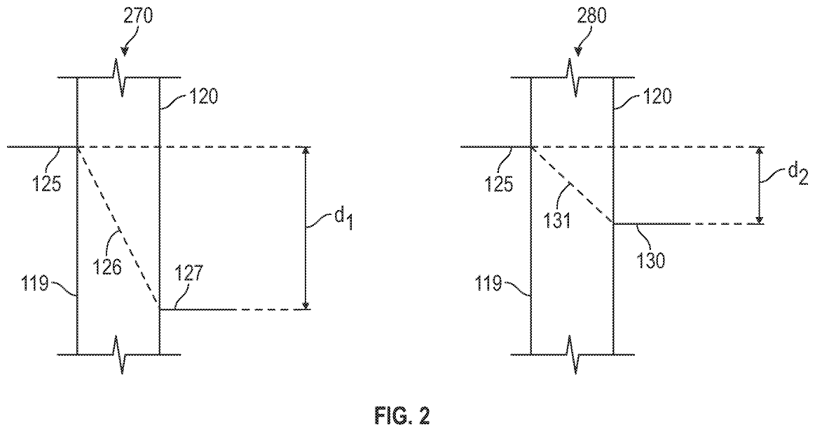

FIG. 2 shows a cross-sectional schematic of hydraulic potential across an infiltrative interface or filter before and after application of Fenton's reagent or modified Fenton's reagent, as may be employed in some embodiments. Infiltrative interfaces 270 and 280 show how a hydraulic gradient 126 and 131 may change between infiltrative surfaces 119 and 120 when Fenton's reagent or modified Fenton's reagent is applied. As can be seen, when bioclogging matter buildup is high, as is shown at schematic 270, the hydraulic gradient between infiltrative surfaces 119 and 120 may be larger than when bioclogging matter build up is low, as is shown at schematic 280. Indicators d1 and d2 of FIG. 2 show the potential gradient difference as may be experienced before and after application of Fenton's reagent or modified Fenton's reagent. Accordingly, water flow at 270 requires more force, i.e., there is more hydraulic resistance than water flow at 280, which requires less force and experiences less hydraulic resistance.

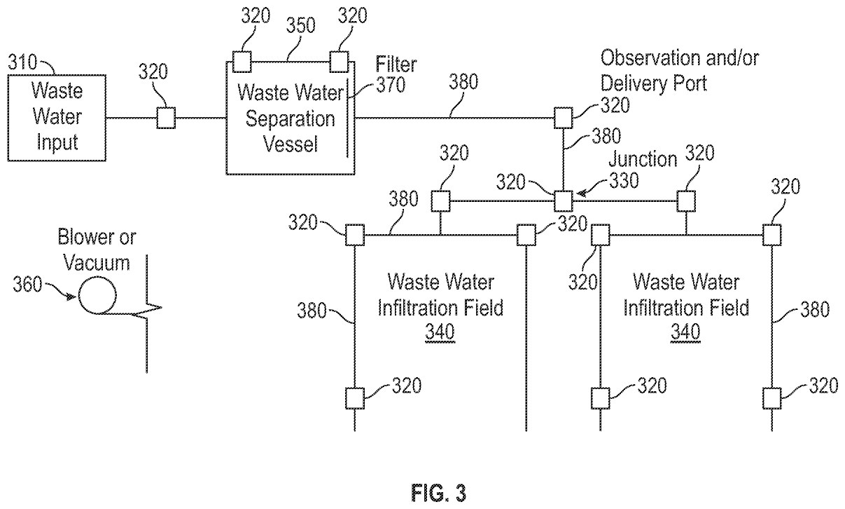

FIG. 3 shows a schematic of a water treatment system that may be rejuvenated in some embodiments. Wastewater input 310 may be any of the various sources, including those identified herein. Multiple observation and/or delivery ports 320 are shown throughout. As can be seen, these ports 320 may be located in or around separation vessel(s) 350, infiltration fields 340, and/or on distribution lines 380 connecting these components. These ports may be used for observation, for solution/reagent/stabilizer delivery, and for other purposes as well. Water treatment systems of embodiments may also employ a vacuum or blower 360 to promote air flow in and/or around the system.

### Fenton's Reagent and Modified Fenton's Reagent of Embodiments

When hydrogen peroxide reacts with some metals, the oxidation process may be catalyzed through the chemical production of free radicals that can have a higher oxidation potential than H₂O₂. For example, when H₂O₂ reacts with ferrous iron, OH⁻ free radicals form, which have a 40% higher oxidation potential than H₂O₂. Combining peroxide with ferrous iron to catalyze the oxidation process was developed by Henry Fenton in the 1890s and is known as Fenton's reagent: Fe²⁺+H₂O₂→Fe³⁺+HO.+OH⁻, where Fe²⁺=Ferrous iron(II), H₂O₂=hydrogen peroxide, Fe³⁺=Ferric iron(III), HO⁻=hydroxyl radical, and OH⁻=hydroxide ion. In this process, ferrous iron(II) reacts with H₂O₂ and is oxidized to ferric iron(III) forming hydroxyl radicals and hydroxide ions. This process takes a powerful oxidant (H₂O₂, reduction potential ˜1.8V) and creates hydroxyl free radicals that are more powerful oxidizers (OH⁻, reduction potential ˜2.8V). The above is a simplification of Fenton's chemistry, with many other potential chain reactions also occurring, depending on the other chemical constituents of the soil or water.

The classic Fenton's reagent, however, may be improved and changed for application in this disclosure and in some embodiments. For example, instability of hydrogen peroxide in the subsurface may be improved in some embodiments. More specifically, application of hydrogen peroxide treatment and Fenton's reagent treatment may cause aggressive reactions near the injection point of the reagents and wasting of the oxidizing agent before it travels through the treatment system and oxidizes contaminants down gradient of the injection point. Related limitations may involve a previous inability to control reactions to a degree that would allow for an entire area of contamination to be treated and the previous requirement for acidic conditions to maintain the reactivity of the solution. The later can be problematic because creating these acidic conditions within systems may be highly invasive and put groundwater and the surrounding environment at risk. In addition, acidic conditions for soils can cause mineralization in the subsurface, which can lead to impermeable layers. As all of these same limitations exist when considering use of Fenton's reagent to treat failed or slowly draining water treatment systems, unmodified Fenton's reagent may be less practical than modified Fenton's reagent for water treatment system rejuvenation.

Comparatively, a modified Fenton's reagent of embodiments may make it more possible for the oxidizing agent and metal catalyst to travel throughout some, most, or the entire extent of the biologically and/or organically clogged hydraulic flow area without requiring or creating acidic conditions. This is achieved through control over the stability of the oxidizing agent and the turnover rate of the metal catalyst. Also, the modified formula can allow for a higher degree of control over the free radicals that are formed in some embodiments. This is significant as these may be the most important oxidizing agents in the process.

A potential limitation to using the classic Fenton's reagent in infiltration fields is that the reagent may be inhibited by neutral or basic pH levels; a pH of ˜3 is commonly required in classic Fenton's chemistry or oxidation will be significantly reduced. Wastewater and stormwater are generally at a near neutral pH and changing the pH of an entire system would add cost and time to a rejuvenation project and would be difficult to maintain for the course of the oxidation treatment.

Additionally, altering a water treatment system to have an acidic pH may not be not in the best interest of the long-term functionality of the water treatment system components, the microbial community, nor the soils surrounding the infiltration field. An additional drawback of the low pH required by the Fenton's reagent is that the pronated form of superoxide, perhydroxyl radical (HO₂⁻), will often dominate over its conjugate, the superoxide anion (O₂⁻). This is a disadvantageous because the perhydroxyl radicals have a lower oxidation potential than hydrogen peroxide, while O₂⁻ is a reductant which can work in concert with the oxidizing radicals to remove recalcitrant contaminants.

A Fenton's reagent or modified Fenton's reagent as may be employed in some embodiments may overcome one or more of the challenges detailed above in soil and water treatment system rejuvenation scenarios. As noted above, the modified Fenton's reagent of embodiments may make it more possible for the oxidizing agent and metal catalyst to travel throughout some, most, or the entire extent of the biologically and/or organically clogged hydraulic flow area without requiring or creating acidic conditions. This is achieved through control over the stability of the oxidizing agent and the turnover rate of the metal catalyst. Also, the modified formula can allow for a higher degree of control over the free radicals that are formed in some embodiments. This is significant as these may be the most important oxidizing agents in the process.

Another inhibitor to using the Fenton's reagent in water treatment systems, has been the instability of oxidizing agent in the subsurface where it is rapidly consumed. If the oxidizing agent is reduced before it is able to react with iron, or other metals, to form radicals, it may likely be ineffective in unclogging biological and/or organic matter. Because of reduced water flow inherent to failed or failing water treatment systems, the metal catalyst, oxidizing agent, or both, may fail to fully infiltrate the pore space of the water treatment system. Thus, in some embodiments, infiltration of a metal catalyst and/or oxidizing agent into the pore space may be measured and tracked. Without control over timing of application and dispersion of the metal catalyst and oxidizing agent, the oxidizing agent may oxidize those organic contaminants that are nearest the injection point and may even be consumed within the septic tank or in the distribution laterals before being applied to the remainder of the water treatment system, such as the infiltration field. Consequently, control, in both time and space, over the reactions and the reactive species produced from the primary reactions in the Fenton's reagent or modified Fenton's methods of embodiments is encouraged in water treatment system rejuvenation applications of embodiments.

In some embodiments, the Fenton's reagent process or modified Fenton's reagent process may comprise at least one oxidizing agent, such as a peroxide, e.g., hydrogen peroxide, and at least one metal catalyst, at a pH of between approximately 5 and approximately 8. The desired pH may be reached and maintained through the use of, e.g., acids, bases, and buffers. Other peroxides, such as peroxy acids, metal peroxides, organic peroxides, and main group peroxides, may also be employed in some embodiments. In some embodiments, the peroxide is preferably stabilized. Stabilizing agents may include, for example, acids and salts thereof, such as phosphoric acid and monopotassium phosphate. In some embodiments, metal catalysts may include metal salts, iron oxyhydroxides, iron chelates, manganese oxyhydroxides, and combinations thereof. Exemplary metal salts include iron (II) and (III) salts, copper (II) salts, and manganese (II) salts. Exemplary iron salts may be selected from the group consisting of ferrous sulfate, ferric sulfate, ferrous perchlorate, ferric perchlorate, ferrous nitrate, and ferric nitrate. Exemplary metal catalysts include iron sulfate or Fe(II/III) EDTA.

Applying the Fenton's reagent or modified Fenton's reagent to water treatment systems in some embodiments may use site specific information to determine the most effective injection location, reagent concentrations, and reagent application scheme to maximize infiltration field remediation efficiency. Additionally, the configuration and design of the water treatment system should preferably be considered in some embodiments: e.g., some infiltration systems have significant void space and a high void space to surface area ratio while other infiltration systems have a low void space to surface area ratio. Generally, the higher the void space to surface area ratio, the greater the amount of oxidizer that is required to contact the oxidizer to the bioclogging matter. When using the Fenton's reagent or modified Fenton's reagent for in-situ oxidation in water treatment system infiltration fields, it is also preferable to consider the soil texture in the soil directly adjacent to the infiltrative interface to inhibit the reaction from agitating the soil particles and allowing the heavier particles from settling down first and the lighter, finer grained particles from settling out last, and forming a less permeable layer that further drops long term hydraulic conductivity values. Controlling the settling out of particles of different sizes may be an additional advantage to using the Fenton's reagent or modified Fenton's reagent in water treatment systems.

The Fenton's reagent or modified Fenton's reagent of embodiments is suitable for oxidation of bioclogging matter buildup in infiltration fields and, thus, remediation of stressed or failed water treatments systems, when timing and concentrations are tailored to achieve suitability for these applications. Likewise, embodiments may be used in water treatment systems that are not yet stressed or failed, in order to completely or partially inhibit stress or failure, again when timing and concentrations are tailored to achieve suitability for these applications.

The Fenton's reagent or modified Fenton's reagent may also be used in removal of toxic contaminants from groundwater, soil, and fractured bedrock, and the like (which may be referred to as “environmental remediation”). However, the conditions in these environmental remediation applications are unlike those found in unclogging water treatment systems and/or stormwater systems and any associated infiltration fields. Moreover, the toxic contaminants removed in environmental remediation are unlike the bioclogging matter removed, reduced, and/or dispersed in water treatment systems. More specifically, environmental remediation is typically directed to removing or reducing high concentrations of toxic contaminants such as volatile organic compounds (VOCs), hydrocarbons, semi-volatile organic contaminants (SVOCs), poly-aromatic hydrocarbons (PAHs), liquid hydrocarbons, petroleum hydrocarbons such as hexadecane, total petroleum hydrocarbon gasoline range organics (TPH-GRO), diesel range organics (TPHDRO), phenolics, toluenes, dioxins, formaldehydes, halocarbons, such as chlorocarbons, alcohols, inorganic compounds, sulfur compounds, cyanide compounds, dense non aqueous phase liquids (DNAPLs), light non-aqueous phase liquid contamination (LNAPLs), free-phase Nonaqueous Phase Liquid (NAPL), and derivatives thereof. In contrast, rejuvenation of water treatment systems in some embodiments may be directed to removing, reducing, or dispersing the physical bulk of bioclogging, e.g., sludge, biomat, biological clogging, organic clogging, etc. or other solids (which collectively may be referred to as “bioclogging matter”) that typically accumulates in water treatment systems treating household wastewater, business wastewater, or stormwater. Although toxic contaminants may be present in water treatment systems, and in bioclogging matter, bioclogging matter typically contains no, or very low concentrations of, toxic contaminants. Whereas other uses of Fenton's reagent and modified Fenton's reagent may be directed to the chemical conversion of toxic contaminants contained in soil and/or groundwater to non-contaminating or harmless compounds, current embodiments may be directed to enhancing hydraulic flow by removing, reducing, and/or dispersing bioclogging material, which is itself harmless in a toxological sense, although it is deleterious to hydraulic conductivity of a water treatment system. Embodiments, may, therefore, be directed to the breakdown and/or debulking of bioclogging matter, so that clogging is reduced or eliminated and hydraulic conductivity is enhanced, increased, prolonged or otherwise rejuvenated.

Accordingly, embodiments may include processes, systems, articles of manufacture, and apparatus directed to using a Fenton's reagent or modified Fenton's reagent to oxidize bioclogging matter accumulation, whether mild, moderate, or severe, in septic systems, stormwater systems, and other water treatment systems. Embodiments may use a Fenton's reagent or modified Fenton's reagent in infiltration fields or other components of water treatment systems that are hydraulically slow or failing under high carbon and/or low oxygen situations. Likewise, embodiments may use a Fenton's reagent or modified Fenton's reagent in infiltration fields or other components of water treatment systems that are not yet hydraulically slow or failing, in order to completely or partially inhibit stress or failure. Embodiments employing a Fenton's reagent or modified Fenton's reagent may be employed at a near neutral pH, may employ peroxide stabilization, and may provide effective control over the turnover rate of metal catalysts thereby allowing the method to rejuvenate a partial, or preferably an entire, infiltration field area. Embodiments may also provide the ability to modify the pH of a system to be between 5 and 8, if it is not already, and to adjust the pH during treatment if this pH range is not maintained.

Embodiments may be directed to water treatment systems, via the application of the Fenton's reagent or modified Fenton's reagent with the tailored timing and tailored concentrations of a stabilized oxidizing agent, metal catalyst, and/or pH modifier in order to maintain a pH of 5 to 8 and to effectively return a stressed or failing water treatment system or other water handling system or components thereof, to improved, preferably to normal, hydraulic functionality. Embodiments may be directed to water treatment systems, by the application the Fenton's reagent or modified Fenton's reagent, with the tailored timing and tailored concentrations of a stabilized oxidizing agent, metal catalyst, and/or pH modifier to maintain a pH of 5 to 8 and to inhibit a stormwater system or other water handling system or components thereof, from slowing or failing. Embodiments may also include adjusting the timing of application of reagents in order to facilitate tailored and thorough distribution of reagents in the water treatment system.

For example, embodiments may be employed to remediate slow, stressed, or failing water treatment systems caused by bioclogging matter accumulation in systems that have been overused, undersized, misused, or that have had incompatible organic or inorganic waste products, stormwater runoff constituents, or septic tank additives entering the systems. In the case of clogging caused by or in-part by inorganic material, the current protocol may be effective but may also not fully rejuvenate the system because of the recalcitrant nature of many inorganic contaminants. In either case, removing inorganic containments may be undertaken in some embodiments.

Some embodiments may comprise using the processes, systems, articles of manufacture, or apparatus with or in water treatment systems that comprise any type of leaching, infiltration or treatment and dispersal system used for returning water back to the environment or used to treat filtration systems that treat water and become flow restricted with organic matter and/or microorganisms. Some embodiments may comprise using the processes, systems, articles of manufacture, or apparatus with or in water treatment systems that comprise: a processing/treatment tank; a secondary treatment tank, an aerobic treatment unit; a distribution system; and an infiltration field comprised of stone, sand, hollow plastic or concrete chambers and/or synthetic media including geotextiles and/or installed directly in native soils, which may comprise stone, cobbles, gravel, ledge, bedrock, engineered media, such as specified sand or septic gravel/stone, and/or soil parent material as the native material surrounding the system. The water treatment system may also comprise passive treatment infrastructure including, but not limited to, a constructed wetland, sand filters, gravel filters, waste stabilizing pond/lagoon, collection basin, rain garden, retention/detention areas, vegetated or dry swales, or underground detention systems. Embodiments may also provide outcomes that comprise vegetation pollutant removal, such as, but not limited to, rain gardens, bioswales, and evapotranspiration systems driven by such species as Salix or Phragmites.

Some embodiments may comprise using the processes, systems, articles of manufacture, or apparatus with or in water treatment system infiltration field(s) with a surface area to void space ratio of <0.5 as well as >0.5. Surface area to void space ratio may be calculated by various methods such as calculations based on of storage volumes or on calculations based on the dimensions of the infiltration field components.

Infiltration fields may comprise sand having various percentages of fines, such as less than 3%, less than 5%, less than 10%, sand with no fines (0%) or other percentages as well. In some embodiments, the fines may float with the application of oxidizing agent, such as hydrogen peroxide, and with the concomitant amount of heavy particles settling downward in the infiltration field upon the application of oxidizing agent, such as hydrogen peroxide.

Some embodiments may comprise using the processes, systems, articles of manufacture, or apparatus with or in a water treatment system are surrounded by or use the following soil textures:
Sands: silt+(1.5*clay)<15%
Loamy sands: silt+1.5*clay>=15% and silt+2*clay<30%
Sandy loams: clay>=7% and clay<20% and sand>52% and silt+2*clay>=30% OR clay<7% and silt<50% and silt+2*clay>=30%)
Loam: clay>=7% and clay<27% and silt>=28% and silt<50% and sand<=52%
Silt Loam: silt>=50% and clay>=12% and clay<27% OR silt>=50% and silt<80% and clay<12%
Silt: silt>=80% and clay<12%
Sandy Clay Loam: clay>=20% and clay<35% and silt<28% and sand>45%
Clay Loam: clay>=27% and clay<40% and sand>20% and sand<=45%
Silty Clay Loam: clay>=27% and clay<40% and sand<=20%
Sandy Clay: clay>=35% and sand>45%
Silty Clay: clay>=40% and silt>=40%
Clay: clay>=40% and sand<=45% and silt<40%

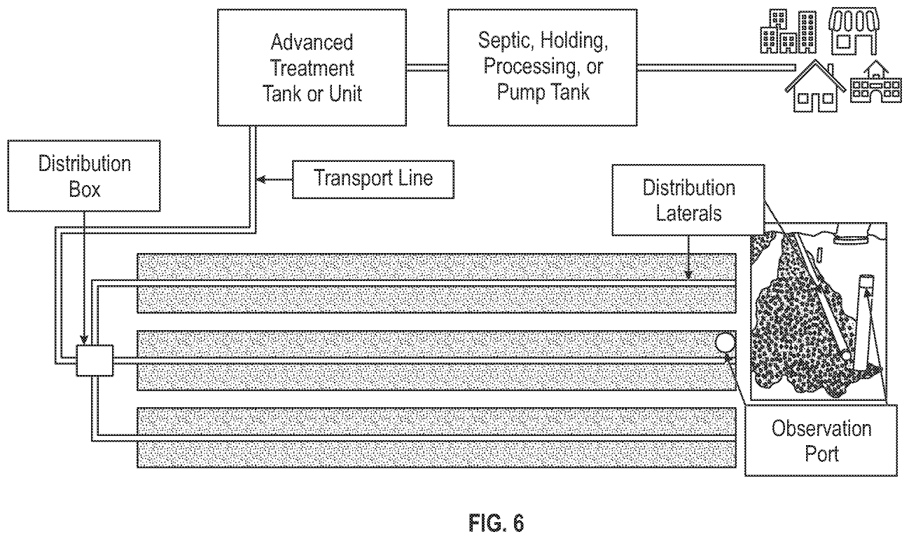

Some embodiments may comprise the application of the Fenton's reagent or modified Fenton's reagent into a water treatment system via a holding tank, a septic tank, a secondary treatment tank, a distribution box, an inspection port, a transport line, a distribution lateral, via an injection point(s) as well as other areas or components in and around a water treatment system. FIGS. 3 and 6 provide non-limiting schematic examples of such systems' layouts. Some embodiments may comprise using the processes, systems, articles of manufacture, or apparatus with or in wastewater systems that serve single residences, multi-family residences, commercial businesses, public organizations/property, private organizations/property, government buildings, and any other situation where onsite wastewater treatment or storm water management is used. Some embodiments may comprise using the processes, systems, articles of manufacture, or apparatus with or in community based onsite wastewater treatment systems and any soil or water-based treatment systems serving as intermediate or final treatment or dispersal for wastewater treatment plants. Some embodiments may comprise using the processes, systems, articles of manufacture, or apparatus with or in systems that employ a geotextile fabric within and/or around the system. The geotextile fabric may stabilize the sediment during treatment to avoid soil stratification by particle size.

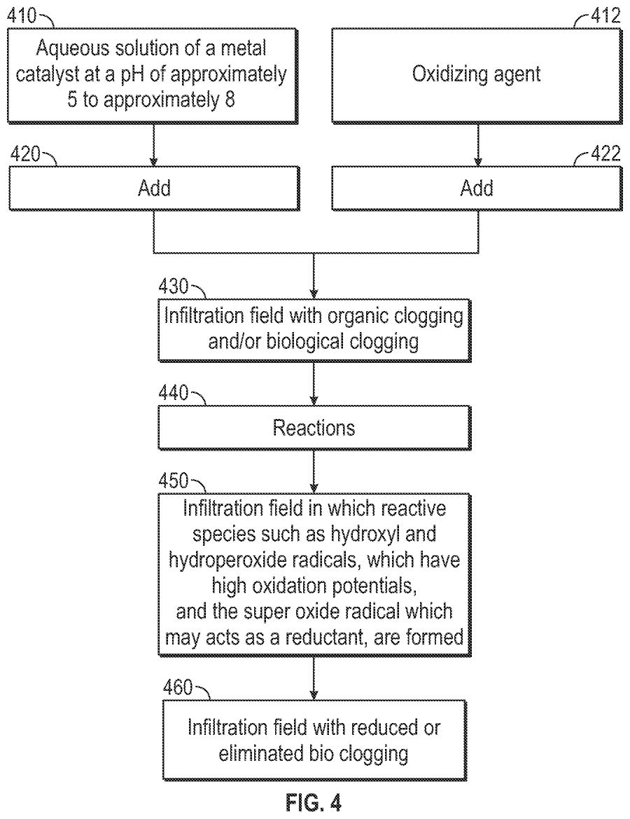

In some embodiments, rejuvenation of a stressed or failed water treatment system may be performed by applying an aqueous solution of a metal catalyst at a pH of approximately 5 to approximately 8 and an oxidizing agent, preferably a stabilized oxidizing agent, at the same, or different, access points in the system. The metal catalyst and oxidizing agent may react in-situ to form reactive species such as hydroxyl and hydroperoxide radicals, which have high oxidation potentials, and the super oxide radical which may act as a reductant. In some embodiments, the reactive species formed during these reactions, and not the peroxide, may be responsible for the majority of the oxidation and contaminant removal that occurs. These radicals may be present throughout some, a majority or most of the infiltration field during treatment because of the peroxide stabilizer and metal catalyst turnover modulated by maintaining a pH of approximately 5 to approximately 8. In some embodiments, the pH of the infiltration field may be measured, and, where the pH of the infiltration field is found to be outside the range of approximately 5 to approximately 8, the pH of the infiltration field may be adjusted using reagents such as acids, bases, buffers, or combinations thereof. Such pH adjustment may occur before or during the treatment with the Fenton's reagent or modified Fenton's reagent, and at one or more times. In some embodiments, the treatment will reduce, eliminate, or disperse bioclogging matter, preferably thereby improving performance. See, e.g., FIG. 4.

In FIG. 4, an aqueous solution of a metal catalyst 410 at a pH of approximately 5 to approximately 8 is introduced 420 to a water treatment system. The water treatment system may comprise an infiltration field 430, which may comprise bioclogging matter. In some embodiments, the water treatment system, including the infiltration field, may have failed or be in various stages of failure. In some embodiments, the water treatment system, including the infiltration filed, may not yet be failing, but the operator of the water treatment system may be desirous to prevent its failure and/or to prolong its effective life and/or to promote or increase hydraulic conductivity of the system. An oxidizing agent, preferably a stabilized oxidizing agent 412, is also introduced 422, optionally at a time interval after the introduction of the metal catalyst 410. The introduction of the metal catalyst 410 and the, preferably stabilized, oxidizing agent 412 may result in a water treatment system, including an infiltration field, in which reactive species such as hydroxyl and hydroperoxide radicals, which have high oxidation potentials, and the super oxide radical, which may act as a reductant, are formed 440, 450. In some embodiments a water treatment system, including an infiltration field, with reduced or eliminated bioclogging matter 460 results.

In some embodiments, at least one oxidizing agent, such as a peroxide and such as hydrogen peroxide, may be employed. Sources of oxidizing agents may be those that typically generate free radicals (e.g., hydroxyl radicals) and include peroxides such as hydrogen peroxide, calcium peroxide, sodium peroxide, and permanganates such as potassium permanganate and the like. Other peroxides, such as peroxy acids, metal peroxides, organic peroxides, and main group peroxides, may also be employed in some embodiments. Ozone may also be employed.

Hydrogen peroxide may be incorporated into an aqueous solution by any convenient means, such as an aqueous hydrogen peroxide or as a solid peroxygen compound, which produces a solution of hydrogen peroxide upon contact with an aqueous solution. Suitable peroxygen compounds include sodium perborate, sodium carbonate peroxide, sodium pyrophosphate peroxide, and sodium peroxide. Alternatively, hydrogen peroxide may be generated within an aqueous solution by inserting an anode and cathode into the aqueous solution and passing a direct current between the anode and cathode thereby reducing oxygen to hydrogen peroxide at the cathode.

In some embodiments, metal catalysts may include metal salts, iron oxyhydroxides, iron chelates, manganese oxyhydroxides, and combinations thereof. Exemplary metal salts include iron (II) and (III) salts, copper (II) salts, and manganese (II) salts. Exemplary iron salts may be selected from the group consisting of ferrous sulfate, ferric sulfate, ferrous perchlorate, ferric perchlorate, ferrous nitrate, and ferric nitrate. Exemplary metal catalysts include iron sulfate or Fe(II/III) EDTA.

In some embodiments, the metal catalyst and the oxidizing agent may be introduced to the water treatment system at the same time. In some embodiments, the metal catalyst and the oxidizing agent may be mixed before being added to the water treatment system, or may come into contact or mix within the water treatment system. In some embodiments, the metal catalyst and the oxidizing agent may be introduced to the water treatment system at different times, with the metal catalyst being introduced before the oxidizing agent; or the oxidizing agent being introduced before the metal catalyst. Trials have shown that, because there is little flow in failed or failing water treatment systems, it may take a relatively long time for the agents to infiltrate into the pore space in a clogged or underperforming water treatment system. In particular, it may take a relatively long time for the metal catalyst to infiltrate into the pore space in a clogged or underperforming water treatment system. In some embodiments, the metal catalyst may be introduced into the water treatment system before the oxidizing agent is introduced. The timing may serve to allow the first-introduced reagent (where the term “reagent” may refer to the metal catalyst or to the oxidizing agent) to infiltrate into the pore space of the water treatment system before the second-introduced reagent is introduced. In some embodiments, the first-introduced reagent may be introduced at least one hour before the second-introduced reagent. In some embodiments, the first-introduced reagent may be introduced at least 24 hours before the second-introduced reagent. In some embodiments, the first-introduced reagent may be introduced between 24 and 48 hours before the second-introduced reagent. In some embodiments, the first-introduced reagent may be introduced at least 48 hours before the second-introduced reagent. In some embodiments, the first-introduced reagent may be introduced at least 1, 2, 3, 4, 5, 10, 15, 20, 24, 28, 32, 34, 36, 40, 44, 48, 52, 54, 60, or more hours before the second-introduced reagent, or at some other interval.

In some embodiments, a stabilizing agent may also be employed. Stabilizing agents may include, for example, acids and salts thereof, such as phosphoric acid and monopotassium phosphate. Salts of condensed phosphates, particularly pyrophosphate salts are well known as stabilizers for peroxygen systems, and other condensed phosphates are well known to be suitable to complex, inactivate, or solubilize polyvalent ions which include decomposition catalysts for hydrogen peroxide.

The stabilizing agent may be combined with the oxidizing agent before the oxidizing agent is introduced to the water treatment system. Alternatively, the stabilizing agent may be added before or after the oxidizing agent. The stabilizing agent may be added more than once. Likewise, in some embodiments, the metal catalyst, the oxidizing agent, a stabilizing agent, each, or combinations thereof may be introduced more than one time, and at varying intervals of time.

In some embodiments, the pH of the water treatment system may be adjusted via the addition of acids, bases, buffers, and the like. The pH of the water treatment system may be adjusted before or after introduction of the metal catalyst, before or after introduction of the oxidizing agent, and at other times as well. The pH of the water treatment system may be tested before or after adjustment or both. In some embodiments, the pH of the water treatment system is maintained at between approximately 5 and approximately 8. In some embodiments, the pH of the water treatment system is maintained at approximately 7.

In embodiments, sub- and supra-atmospheric pressure gradients may be used to move the metal catalyst and/or oxidizing agent into the clogged treatment system. In embodiments, pump(s), vacuums, blowers, or other pressure producing apparatus may be used to move the metal catalyst and/or oxidizing agent into the clogged treatment system.

Inorganic materials can create impermeable layers within an infiltrative field. Some of the free radicals and other reactants produced during the downstream reactions of the Fenton's reagent or modified Fenton's reagent have also shown promise in removing inorganic contaminants. Embodiments may also be directed to processes, systems, articles of manufacture, and apparatus for treating infiltration fields clogged by inorganic materials. Embodiments may also provide for the rejuvenation of other onsite wastewater treatment and stormwater system components in addition to or instead of rejuvenation of infiltration fields.

In some embodiments, internal areas and void spaces in the infiltration field may be calculated, and reagent may be added to fill some or all of the void space in order to oxidize organic/biologic matter buildup on all surface area in the infiltration field. In some embodiments the ratio of void space to surface area may be calculated to ensure that all of the void spaces are completely filled with the reagent and, thus, some, most, or all surface areas are oxidized.

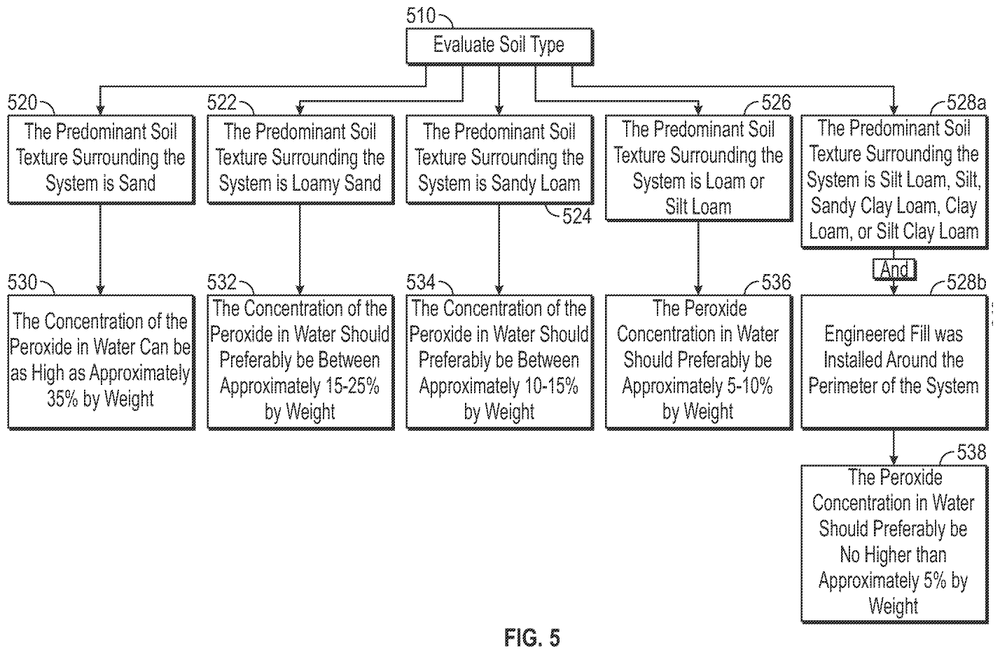

In some embodiments, a soil evaluation of the site may be obtained or performed, and the soil texture may be used to make informed decisions about the concentration of oxidizing agent needed to reduce or eliminate bioclogging matter while protecting the soil structure surrounding the infiltration area. Some exemplary embodiments, where peroxide is employed, are provided. This exemplary information is set forth as a schematic flow chart in FIG. 5. The soil type may be evaluated at 510 of FIG. 5. In some embodiments, when the predominant soil texture surrounding the system is sand 520, the concentration of the peroxide in water can be as high as approximately 35% by weight 530. Throughout this paragraph, the percentages by weight refer to the final percentage by weight of the peroxide in the infiltration field. In some embodiments, when the predominant soil texture surrounding the system is loamy sand 522, the concentration of the peroxide in water should preferably be between approximately 15-25% by weight 532. In some embodiments, when the predominant soil texture surrounding the system is sandy loam 524, the concentration of the peroxide in water should preferably be between approximately 10-15% by weight 534. In some embodiments, when the predominant soil texture surrounding the system is loam or silt loam 526, the peroxide concentration in water should preferably be approximately 5-10% by weight 536. In some embodiments, if the predominant soil texture surrounding the system is silt loam, silt, sandy clay loam, clay loam, or silt clay loam 528a, this treatment is preferably advisable when engineered fill was installed around the perimeter of the system 528b; if this method is used in these soil textures, the peroxide concentration in water should preferably be no higher than approximately 5% by weight 538. In some embodiments, the soil is “predominantly” a given texture when it is approximately 100%, 95%, 90%, 85%, 80%, 75%, 70%, 65%, 60%, 55%, or 51% that texture. In some embodiments, the soil is “predominantly” a given texture when it is at least more than half of that texture.

In some embodiments, the oxidizing agent, preferably stabilized, and metal catalyst may be added continually throughout the treatment process. In some embodiments, the oxidizing agent, preferably stabilized, and metal catalyst may be alternatively introduced to the system in rounds. Adding the solutions in rounds may be advantageous when the infiltration field and soils surrounding the infiltration field are highly permeable. As mentioned above, the pH of the infiltration field may also be assessed, monitored, and adjusted.

In some embodiments, when applied continuously or in rounds, the metal catalyst may be added to the system first, followed by the addition of the oxidizing agent, preferably stabilized. In some embodiments, when applied continuously or in rounds, the oxidizing agent, preferably stabilized, is added to the system first, followed by the addition of the metal catalyst to the system. In some embodiments, when applied continuously, the oxidizing agent may be added to the system and allowed time to travel throughout the systems, which may maximize the amount of area treated, and then the metal catalyst may be added to the system.

In some embodiments, the oxidizing agent, preferably stabilized, and metal catalyst reagent may be added by any of the methods detailed herein (i.e., in rounds or continuously, with the metal catalyst added first, the oxidizing agent added first, or the oxidizing agent added and dispersed throughout the systems before addition of the metal catalyst) to the treatment, holding tank, distribution box, transport line, injection port, distribution laterals, splitter valve of a zoned system, and/or secondary treatment tank of a system. In some embodiments, the oxidizing agent and metal catalyst may be added by any of the methods detailed above and dosed by gravity distribution and/or pressurized distribution to and within the system. In some embodiments, the oxidizing agent and metal catalyst may be added to the infiltration field via inspection port or other means of entry. In some embodiments, the oxidizing agent and metal catalyst may be added to the infiltration field at more than one point. In some embodiments, the oxidizing agent and metal catalyst may be added to the infiltration field at different points.

As noted above, in some embodiments the Fenton's reagent or modified Fenton's reagent may be used to remove organic accumulations from any component of the onsite wastewater treatment system other than infiltration fields, including but not limited to, septic tanks, secondary tanks, media or sand filters, transport lines, and distribution laterals.

In some embodiments, ponded water may be removed prior to introducing the catalyst and/or the oxidizer. This ponded water may be evident above ground and may not be evident above ground. For example, a leachfield may be dewatered during processes of embodiments. This dewatering may be performed by pumping it out. Optionally pneumatic soil fracturing or excavating a pit adjacent to the system can be utilized to dewater, but then additional catalyst and/or oxidizer may be required since a significant percentage will flow through these pathways.

In some embodiments, the Fenton's reagent or modified Fenton's reagent may be kept at a temperature between 0° C. and −196° C. using liquid nitrogen to stabilize the superoxide anion. In some embodiments, a preferable infiltrative surface area/void space to surface area ratio of 1 sq. ft: 0.014 gallons, may be employed. In some embodiments, normal hydraulic functionality may be considered to be achieved when any surface breakout of wastewater is significantly reduced or eliminated, ponding within the infiltration is significantly reduced or eliminated, building pipes drain freely or more freely than before the treatment, drains in the building are free or freer of septic smell, and any other sign of improved infiltration is detected.

Various exemplary characteristics of embodiments may also comprise one or more of the following and modifications or combinations thereof: the amount of oxidizer and catalyst added in adequate volumes may cover approximately 80% of the bioclogging matter for at least five minutes; the majority of the infiltration field may be filled with sand and stone/gravel; the infiltration field may comprise a geotextile or chamber distribution system onto sand, native soil, or other media; the infiltration field may comprise a sand or media filter; the infiltration field may be dosed via gravity or pressure distribution from a component other than a septic tank (i.e. aerobic treatment unit, media filter, etc.); the infiltration field may be dosed from the septic tank via a gravity distribution system; the infiltration field may be dosed from the septic tank via a pump tank; the surface area to void space in the infiltration field may be approximately <0.5; the surface area to void space in the infiltration field may be approximately >0.5; soil surrounding the system may be one of the following textures: sand, loamy sand, loam, silt loam, silt, sand clay loam, clay loam, silty clay loam, sandy clay, silty clay, or clay; the water treatment system may be surrounded by gravel, cobble, bedrock, ledge, or soil parent material; geotextile fabric may be used within or around the water treatment system to stabilize the soil surrounding the system to protect the surrounding soil structure; the oxidizing agent may be a peroxide; the peroxide source may be selected from hydrogen peroxide, sodium peroxide and calcium peroxide; hydrogen peroxide may be the peroxide source; a stabilizer may be selected from acids, salts, or a combination of acids and salts; a stabilizer may be selected from monopotassium phosphate, phosphoric acid, or sulfuric acid, or a combination thereof; the oxidizing agent may be at least in part OH. (hydroxyl radicals); superoxide anions may act as a reductant; the addition of the oxidizing agent and catalyst solution may be added at an elevated pressure; the elevated pressure may be from approximately 1 to approximately 100 psi; the concentration of the peroxide diluted in water may be as high as approximately 35% by weight; the concentration of the peroxide diluted in water may be less than approximately 10% by weight; the catalyst mixture may be maintained at a near neutral (approximately 5-8) pH through the addition of a pH altering agent to the solution; the pH altering agent may be water, a base, or a combination of these; ferric chloride (FeCl₃) may be the metal catalyst in the reagent; ferrous sulfate (FeSO₄) may be the metal catalyst in the reagent; ferrous EDTA chelate (C₁₀H₁₂FeN₂O₈) may be the metal catalyst in the reagent; the metal catalyst and the oxidizing agent may be alternately added in-situ to the infiltration field; the aqueous catalyst mixture may be first added in-situ to the infiltration field and then the oxidizing agent is added afterwards; the oxidizing agent may be first added in-situ to the infiltration field and then the aqueous catalyst mixture may be added afterwards; solutions may be added to the septic or holding tank; the solutions may be added to a distribution box; the solution may be added to the transport line between the septic tank and the infiltration field; a solution may be added to an observation port in the infiltration field; the solution may be added to the distribution laterals; a solution may be added by injection point or well; the method may be used on a constructed wetland or waste stabilizing pond/lagoon used to treat septic system effluent or sewage effluent; the oxidizing agent may be added to a splitter valve of a zoned infiltration field; a solution may be used to oxidize organic matter in distribution laterals; the oxidizing agent and the catalyst mixture may be added in-situ to the infiltration field continuously; the method may be used on a constructed wetland, used to treat septic system effluent or sewage effluent; the permeability class of the native soil around and beneath an infiltration field may be very rapid (approximately >25.4 cm/hour) to moderate (approximately 6.3-2.0 cm/hour); the permeability class of the native soil around and beneath an infiltration field may be moderately slow (approximately 2.0-0.5 cm/hour) to very slow (approximately <0.13 cm/hour); the oxidizing agent and/or the metal catalyzing solution may be applied at a temperature between approximately 0° C. and −1%° C.; the oxidizing agent and/or the metal catalyzing solution may be applied at a temperature above 0° C.; biochemical oxygen demand (BOD) from the infiltration field within the septic tank may be measured and this information may be used to inform the amount of oxidizing agent and metal catalyst added to the system; the average BOD from the tank may be approximately >150 mg/L or the BOD from the infiltration field may be approximately >100 mg/L, and approximately 75% of the void space within the infiltration field may be filled; the average BOD from the tank may be approximately 150-100 mg/L or the BOD from the infiltration field may be approximately 100-50 mg/L, and approximately 50% of the void space within the infiltration field may be filled; the average BOD from the tank may be approximately <100 mg/L or the BOD from the infiltration field may be approximately <5 mg/L, and approximately 25% of the void space within the infiltration field may be filled; the water treatment system and/or bioclogging material to be treated may contain no or low concentrations of toxic contaminants; the water treatment system and/or bioclogging material to be treated may contain lower concentrations of toxic contaminants than would typically be found at an industrial waste-contaminated site; and/or the water treatment system and/or bioclogging material to be treated may contain low concentrations of toxic contaminants lower than specified as acceptable by government regulations.

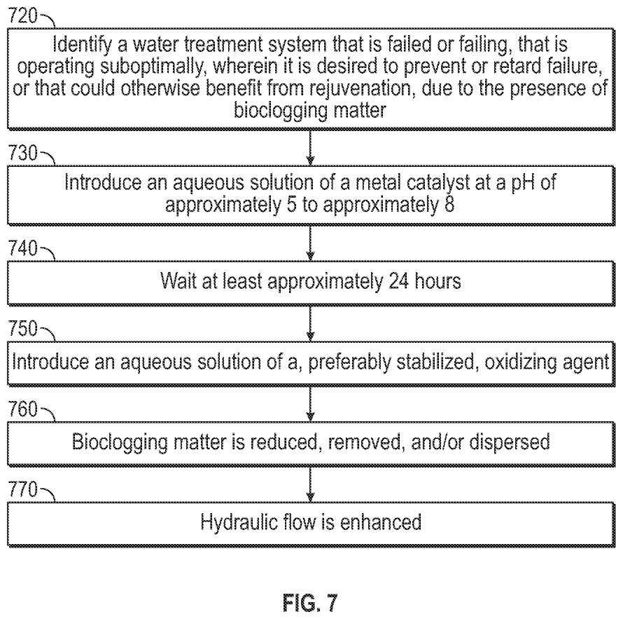

FIG. 7 provides a high-level schematic overview of exemplary processes, as may be used in embodiments. At step 720, a water treatment system that is failed or failing, that is operating sub optimally, wherein it is desired to prevent or retard failure, or that could otherwise benefit from rejuvenation, due to the presence of bioclogging matter, is identified. At step 730, an aqueous solution of a metal catalyst at a pH of approximately 5 to approximately 8 is introduced to the water treatment system. At step 740, in embodiments, at least approximately 24 hours may be allowed to elapse to allow the metal catalyst to disperse within the water treatment system. At step 750, an aqueous solution of an oxidizing agent is introduced. However, more or fewer hours, such as one hour, may be allowed to elapse between introduction of the aqueous solution of a metal catalyst and the introduction of the aqueous solution of an oxidizing agent, in embodiments. In embodiments, the aqueous solution of a metal catalyst and the aqueous solution of an oxidizing agent may be mixed together before being introduced to the water treatment system, may be introduced to the water treatment system at the same time, or both. In embodiments, the oxidizing agent is preferably stabilized. However, the oxidizing agent may not be stabilized. Due to chemical reactions, bioclogging matter may be reduced, removed, and/or dispersed at 760. Due to the reduction, removal, and/or dispersal of bioclogging matter, hydraulic flow of the water treatment system may be enhanced, at 770.

### EXAMPLES

The following examples are presented to instruct one skilled in the art in practicing some embodiments or features of embodiments and are not intended to limit the scope of the invention.

### Example 1: SBox Fenton's Reagent Trial

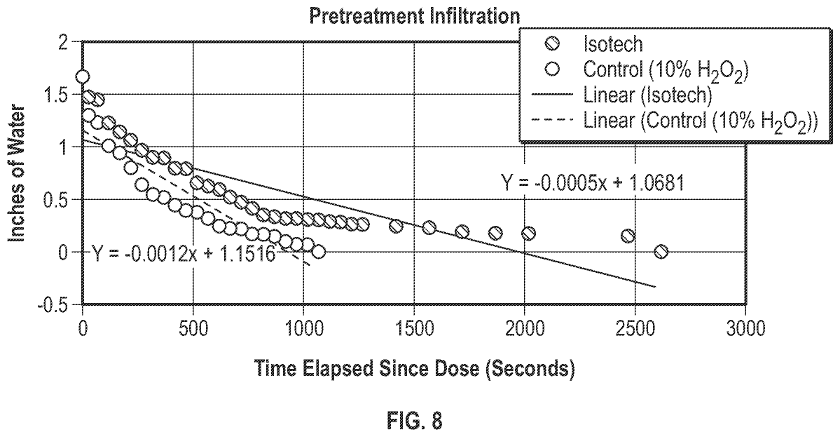

The first (left) and third (right) fingers of an SBox™ mesocosm were filled with treatment media. Pretreatment infiltration rates were established using a time lapse camera and image software. The change in height of water over time was measured, and the rate of change (i.e., slope) of the falling water was calculated. The results are set forth below and in FIG. 8. The pretreatment rate of change was as follows:

Finger #1:-0.0005 in/second.

Finger #3:-0.0012 in/second.

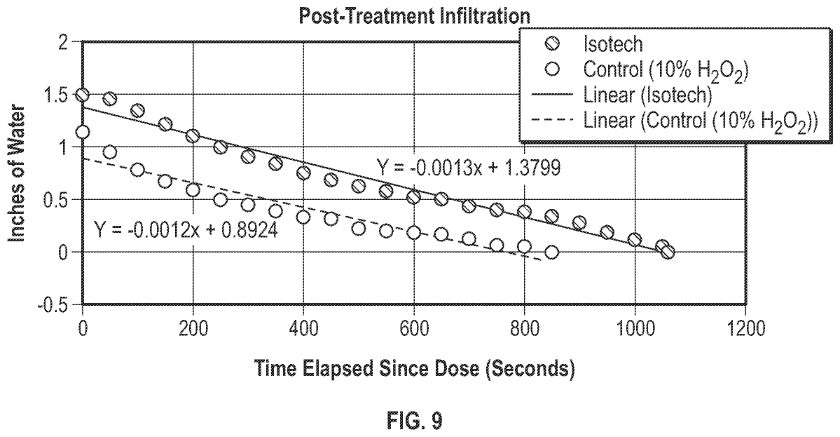

The first SBox finger (far left finger) was treated with 500 mL catalyst components followed by 1000 mL of 10% stabilized H₂O₂: The third finger from the left was treated with 1000 mL 10% H₂O₂ as a control. The change in height of water over time was measured, and the rate of change (i.e., slope) of the falling water was calculated. The results are set forth in FIG. 9. The post-treatment rate of change was as follows:

Finger #1:-0.0013 in/second.

Finger #3:-0.0012 in/second.

Conclusions: The catalyst and stabilized H₂O₂ increased infiltration rates by an order of magnitude (160%) while the 10% H₂O₂ alone did not change infiltration rates, as compared to pretreatment rates.

### Example 2: Sand/Silt Lysimeter Fenton's Reagent Trial

A completely failed lysimeter with 14.5″ sand/silt was obtained. Sitting water was syphoned off of the sand/silt so approximately 6″ was sitting on media to determine starting infiltration rate. Pretreatment infiltration rates were established with a tape measure. After establishing infiltration rate, remaining sitting water was syphoned off the sand/silt.

The oxidizer was prepared as follows: 34% H₂O₂ was diluted to 10%, and 2.5 L of 10% H₂O₂ was combined with 37.5 g of stabilizer. The final concentration of stabilizer was 15 g/L.

The catalyst was prepared as follows: 2.5 g of ISOTECH™ Comp B2, 10.5 g ISOTECH™ Comp A, and 7.5 g ISOTECH™ Comp B4 were dissolved into 1.25 L of H₂O.

The full volume of catalyst was added to the failed lysimeter. 24 hours was allowed to elapse, so the liquid could infiltrate into the pore space. Then, the stabilized H₂O₂ was added to the failed lysimeter.

After the catalyst and stabilized H₂O₂ completely infiltrated, 3000 mL (approximately one inch) of tap water was added to the treated lysimeter, and infiltration was tracked.

Results: Before treatment, the standing water in the failed lysimeter fell >⅛″ per day. 2.5 L stabilized H₂O₂ and 1.25 L catalyst infiltrated within 24 hours. After treatment, the added tap water fell ½″ in 3 hours.

Conclusion: The catalyst and stabilized H₂O₂ increased infiltration rates from >⅛″ in 24 hours to ½″ in 3 hours, i.e., an increase from approximately 0.005″ per hour to 0.08″ per hour, a 1500% increase in infiltration.

Reagents: Although reagents from In-Situ Oxidative Technologies, Inc. (ISOTEC) (11 Princess Road, Suite A, Lawrenceville, N.J. 08648; Tel: (609) 275-8500; Fax: (609) 275-%08; Email: info@isotec-inc.com) were used, other catalysts and stabilizers could be employed. Commercially available hydrogen peroxide was used, but other oxidizers could be employed.

The preceding detailed description is merely illustrative in nature and is not intended to limit the embodiments of the subject matter of the application or uses of such embodiments. Numerous embodiments are possible beyond those specifically described above and below. The embodiments described here are illustrative and should not be considered to be limiting. This includes that, processes described herein may be undertaken in various orders unless a specific order is called for in the applicable claim or description. Moreover, fewer or more features or actions may accompany those specifically described herein. Likewise, disclosed embodiments, whether in the brief summary or detailed description may be further modified, including being altered using features and processes selected from different embodiments and using features and processes in different orders and configurations.

There are various adaptations of embodiments, and many permutations may be employed within the spirit and scope of this disclosure. Those of skill will understand that the invention is not to be limited to only those embodiments described herein and that other embodiments and applications consistent with the teachings herein would also fall with the scope of this disclosure.

As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

While embodiments have been illustrated herein, they are not intended to restrict or limit the scope of the appended claims to such detail. In view of the teachings in this application, additional advantages and modifications will be readily apparent to and appreciated by those having ordinary skill in the art. Accordingly, changes may be made to the above embodiments without departing from the scope of the invention.

The terminology used herein is for the purpose of describing particular embodiments only and is not intended to be limiting of the invention. As used herein, the singular forms “a,” “an” and “the” are intended to include plural forms as well, unless the context clearly indicates otherwise.

It will be further understood that the terms “comprises” and/or “comprising,” when used in this specification, are open ended terms and specify the presence of stated features, integers, steps, operations, elements, and/or components, but do not preclude the presence or addition of one or more other features, integers, steps, operations, elements, components, and/or groups thereof.

“Configured to” connotes structure by indicating a device, such as a unit or component, includes structure that performs a task or tasks during operation, and such structure is configured to perform the task even when the device is not currently operational (e.g., is not on/active). A device “configured to” perform one or more tasks is expressly intended to not invoke 35 U.S.C. § 112, (f) or sixth paragraph.

As used herein, the terms “about” or “approximately” in reference to a recited numeric value, including for example, whole numbers, fractions, and/or percentages, generally indicates that the recited numeric value encompasses a range of numerical values (e.g., +/−5% to 10% of the recited value) that one of ordinary skill in the art would consider equivalent to the recited value (e.g., performing substantially the same function, acting in substantially the same way, and/or having substantially the same result). As used herein, the terms “about” or “approximately” in reference to a recited non-numeric parameter generally indicates that the recited non-numeric parameter encompasses a range of parameters that one of ordinary skill in the art would consider equivalent to the recited parameter (e.g., performing substantially the same function, acting in substantially the same way, and/or having substantially the same result).

Recitation of ranges of values herein are merely intended to serve as a shorthand method of referring individually to each separate value falling within the range, unless otherwise indicated herein, and each separate value is incorporated into the specification as if it were individually recited herein.

“First,” “Second,” etc. As used herein, these terms are used as labels for nouns that they precede, and do not imply any type of ordering (e.g., spatial, temporal, logical, etc.). For example, reference to a “first” item does not necessarily imply that this item is the item in a sequence; instead, the term “first” is used to differentiate this item from another item (e.g., a “second” item).

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

“Improve”, “Enhance”, or “Promote”—As used herein, improve, enhance, or promote is used to describe an increasing or maximizing effect. When a component, element, or feature is described as improving, enhancing, or promoting an action, motion, or condition it may produce the desired result or outcome or future state completely. However, when a component, element, or feature is referred to as improving, enhancing, or promoting a result or outcome or state, it need not completely produce the desired result or outcome or state; rather only an increase is required, as compared to the result or outcome or state in the absence of the component, element, or feature. Additionally, “improve”, “enhance”, or “promote” can also refer to an increase of the outcome, performance, and/or effect which might otherwise occur, even in the absence of the component or feature.

“Prolong”-As used herein, prolong is used to describe an effect of increase or lengthening of time. When a component, element, or feature is described as prolonging an action, motion, or condition it may produce the desired time increase or lengthening effect as compared to the time the action, motion, or condition would last or endure without the presence of the component, element, or feature.

The scope of the present disclosure includes any feature or combination of features disclosed herein (either explicitly or implicitly), or any generalization thereof, regardless of whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The corresponding structures, material, acts, and equivalents of any means or steps plus function elements in the claims are intended to include any structure, material or act for performing the function in combination with other claimed elements. The description of certain embodiments of the present invention have been presented for purposes of illustration and description, but is not intended to be exhaustive or limited to the invention in the form disclosed. Many modifications and variations will be apparent to those of ordinary skill without departing from the scope and spirit of the invention. These embodiments were chosen and described in order to best explain the principles of the invention and the practical application, and to enable others of ordinary skill in the art to understand the invention for embodiments with various modifications as are suited to the particular use contemplated.

What is claimed is:

1. A method for rejuvenation of a water treatment system or water infiltration field having bioclogging matter, the method comprising:
adding at least one metal catalyst in aqueous solution, and at least one oxidizing agent in aqueous solution, to the water treatment system, to at least one infiltration field, or to both.

2. The method of claim 1 wherein the at least one metal catalyst and the at least one oxidizing agent are mixed together before being added to the water treatment system, to the at least one infiltration field, or to both; the at least one metal catalyst and the at least one oxidizing agent are added to the water treatment system, to the at least one infiltration field, or to both at the same time; or both.

3. The method of claim 1 wherein the at least one metal catalyst is added to the water treatment system, to the at least one infiltration field, or to both first, and the at least one oxidizing agent is added to the water treatment system, to the at least one infiltration field, or to both second.

4. The method of claim 3 wherein the at least one oxidizing agent is added to the water treatment system, to the at least one infiltration field, or to both approximately 1 hour or more after adding the at least one metal catalyst.

5. The method of claim 1 wherein the at least one oxidizing agent is added to the water treatment system, to the at least one infiltration field, or to both first, and the at least one metal catalyst is added to the water treatment system, to the at least one infiltration field, or to both second.

6. The method of claim 5 wherein the at least one metal catalyst is added to the water treatment system, to the at least one infiltration field, or to both approximately 1 hour or more after adding the at least one oxidizing agent.

7. The method of claim 1 wherein bioclogging matter is reduced or removed after adding one or both of the aqueous solutions to the water treatment system, to the at least one infiltration field, or to both.

8. The method of claim 1 wherein a hydraulic flow in the water treatment system is increased after adding one or both of the aqueous solutions to the water treatment system, to the at least one infiltration field, or to both.

9. The method of claim 1 wherein the at least one metal catalyst in aqueous solution comprises ferrous iron(II) chelates or salts, or ferric iron(III) chelates or salts, or a combination thereof; and the method further comprises,
maintaining the pH of the at least one metal catalyst in aqueous solution between approximately 5 and approximately 8;
and adding the at least one metal catalyst in aqueous solution in-situ to the infiltration field or a treatment tank in a quantity to fill at least a quarter of the void space within the infiltration field or treatment tank when combined with the at least one oxidizing agent in aqueous solution.

10. A method for the in-situ rejuvenation of a water treatment system with reduced hydraulic flow from bioclogging matter, the method comprising:
providing at least one oxidizing agent in aqueous solution and at least one metal catalyst in aqueous solution; and
adding the at least one oxidizing agent in aqueous solution and the at least one metal catalyst in aqueous solution to at least one infiltration field of the water treatment system.

11. The method of claim 10, wherein the at least one oxidizing agent is added to the at least one infiltration field approximately 1 hour or more after adding the at least one metal catalyst.

12. The method of claim 10 wherein:
providing at least one oxidizing agent in aqueous solution comprises providing a solution comprising (i) a stabilized oxidizing agent, (ii) an oxidizing agent and phosphoric acid (HPO₄), monopotassium phosphate (KH₂PO₄), sulfuric acid (H₂SO₄), or a combination thereof, or (iii) both;
providing a metal catalyst in aqueous solution comprises providing a solution comprising ferrous iron(II) chelates or salts, or ferric iron(III) chelates or salts, or a combination thereof; and
adding the aqueous catalyzing solution to an infiltration field of a water treatment system comprises providing the aqueous solution and the aqueous catalyzing solution in amounts such that, when the solutions are combined, the molar ratio of metal catalyst to oxidizing agent is in the range of 0.5 to 1.5:1; and wherein
adding the at least one oxidizing agent in aqueous solution and the at least one metal catalyst in aqueous solution to at least one infiltration field of the water treatment system comprises adding the aqueous solutions in-situ to at least one infiltration field or treatment tank of the water treatment system in a quantity sufficient to fill at least a quarter of the void space within the infiltration field or treatment tank.

13. A method for the in-situ rejuvenation of a water treatment system with reduced hydraulic flow from bioclogging matter, the method comprising:
preparing an aqueous catalyzing solution comprising at least one metal catalyst; and
adding the aqueous catalyzing solution in-situ to at least one infiltration field or treatment tank of the water treatment system in an adequate quantity to fill at least a quarter of the void space within the infiltration field or treatment tank when combined with at least one oxidizing agent in aqueous solution, wherein said at least one oxidizing agent is also added to the at least one infiltration field or treatment tank, wherein the addition of the aqueous catalyzing solution and at least one oxidizing agent increases a hydraulic flow in the at least one infiltration field or treatment tank previously hindered by bioclogging matter.

14. The method of claim 13 wherein the aqueous catalyzing solution and the at least one oxidizing agent in aqueous solution are mixed together before being added to the at least one infiltration field or treatment tank; the aqueous catalyzing solution and the at least one oxidizing agent in aqueous solution are added to the at least one infiltration field or treatment tank at the same time; or both.

15. The method of claim 13 wherein the aqueous catalyzing solution is added to the at least one infiltration field or treatment tank first, and the at least one oxidizing agent in aqueous solution is added to the at least one infiltration field or treatment tank second.

16. The method of claim 15 wherein the at least one oxidizing agent in aqueous solution is added to the at least one infiltration field or treatment tank approximately 1 hour or more after adding the aqueous catalyzing solution.

17. The method of claim 13 wherein the at least one oxidizing agent in aqueous solution is added to the at least one infiltration field or treatment tank first, and the aqueous catalyzing solution is added to the at least one infiltration field or treatment tank second.

18. The method of claim 17 wherein the aqueous catalyzing solution is added to the at least one infiltration field or treatment tank approximately 1 hour or more after adding the at least one oxidizing agent in aqueous solution.

19. The method of claim 13 wherein the at least one oxidizing agent in aqueous solution (i) is stabilized, (ii) is combined with phosphoric acid (HPO₄), monopotassium phosphate (KH₂PO₄), sulfuric acid (H₂SO₄), or a combination thereof, or (iii) both.

20. The method of claim 13 wherein biochemical oxygen demand (BOD) from the infiltration field within the septic tank is measured and this information is used to inform the amount of oxidizing agent and metal catalyst added to the system.
